(19) United States
(12) Patent Application Publication
(10) Pub. No.: US 2017/0039750 A1
(43) Pub. Date: Feb. 9, 2017

(54) AVATAR FACIAL EXPRESSION AND/OR SPEECH DRIVEN ANIMATIONS

(71) Applicant: Intel Corporation, Santa Clara, CA (US)

(72) Inventors: Xiaofeng TONG, Beijing (CN); Qiang LI, Beijing (CN); YangzhouU DU, Beijing (CN); Wenlong LI, Beijing (CN)

(21) Appl. No.: 14/914,561

(22) PCT Filed: Mar. 27, 2015
(86) PCT No.: PCT/CN2015/075227

§ 371 Date: Feb. 25, 2016

(51) Int. Cl. G06T 13/20; G10L 15/18; G06T 7/00; G06F 3/01; G06T 7/20; G10L 15/02; G06T 13/40

(52) U.S. Cl. CPC G06T 13/205; G10L 15/02; G10L 15/1822; G06T 13/40; G06F 3/012; G06T 7/20; G06T 7/004; G10L 2015/025; G06T 2207/30201

(57) ABSTRACT

Apparatuses, methods and storage medium associated with animating and rendering an avatar are disclosed herein. In embodiments, an apparatus may include a facial expression and speech tracker to respectively receive a plurality of image frames and audio of a user, and analyze the image frames and the audio to determine and track facial expressions and speech of the user. The tracker may further select a plurality of blend shapes, including assignment of weights of the blend shapes, for animating the avatar, based on tracked facial expressions or speech of the user. The tracker may select the plurality of blend shapes, including assignment of weights of the blend shapes, based on the tracked speech of the user, when visual conditions for tracking facial expressions of the user are determined to be below a quality threshold. Other embodiments may be disclosed and/or claimed.

### TECHNICAL FIELD

The present disclosure relates to the field of data processing. More particularly, the present disclosure relates to animation and rendering of avatars, including facial expression and/or speech driven animations.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

As user's graphic representation, avatar has been quite popular in virtual world. However, most existing avatar systems are static, and few of them are driven by text, script or voice. Some other avatar systems use graphics interchange format (GIF) animation, which is a set of predefined static avatar image playing in sequence. In recent years, with the advancement of computer vision, camera, image processing, etc., some avatar may be driven by facial expressions. However, existing systems tend to be computation intensive, requiring high-performance general and graphics processor, and do not work well on mobile devices, such as smartphones or computing tablets. Further, existing systems do not take into consideration of the fact that at times, visual conditions may not be ideal for facial expression tracking. Resultantly, less than desirable animations are provided.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of a pocket avatar system, according with various embodiments.

FIG. 2 illustrates the facial expression tracking function of FIG. 1 in further detail, according to various embodiments.

FIG. 3 illustrates an example process for tracking and analyzing speech of a user, according to various embodiments.

FIG. 4 is a flow diagram illustrating an example process for animating an avatar based on facial expressions or speech of a user, according to various embodiments.

FIG. 5 illustrates an example computer system suitable for use to practice various aspects of the present disclosure, according to the disclosed embodiments.

FIG. 6 illustrates a storage medium having instructions for practicing methods described with references to FIGS. 2-4, according to disclosed embodiments.

### DETAILED DESCRIPTION

Apparatuses, methods and storage medium associated with animating and rendering an avatar are disclosed herein. In embodiments, an apparatus may include a facial expression and speech tracker, including a facial expression tracking function and a speech tracking function, to respectively receive a plurality of image frames and audio of a user, and analyze the image frames and the audio to determine and track facial expressions and speech of the user. The facial expression and speech tracker may further include an animation message generation function to select a plurality of blend shapes, including assignment of weights of the blend shapes, for animating the avatar, based on tracked facial expressions or speech of the user.

In embodiments, the animation message generation function may select the plurality of blend shapes, including assignment of weights of the blend shapes, based on the tracked speech of the user, when visual conditions for tracking facial expressions of the user are determined to be below a quality threshold; and select the plurality of blend shapes, including assignment of weights of the blend shapes, based on the tracked facial expressions of the user, when visual conditions for tracking facial expressions of the user are determined to be at or above a quality threshold.

Either case, in embodiments, the animation message generation function may output the selected blend shapes and their assigned weights in the form of animation messages.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

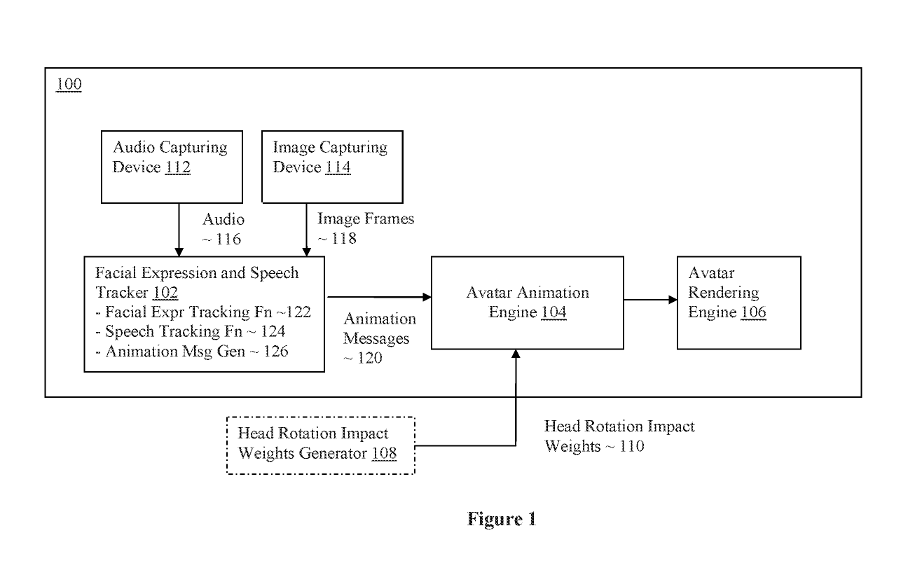

Referring now to FIG. 1, wherein a pocket avatar system, according to the disclosed embodiments, is shown. As illustrated, in embodiments, pocket avatar system 100 for efficient animation of an avatar may include facial expression and speech tracker 102, avatar animation engine 104, and avatar rendering engine 106, coupled with each other as shown. As will be described in more detail below, pocket avatar system 100, in particular, facial expression and speech tracker 102 may be configured to enable an avatar to be animated based on either facial expressions or speech of the user. In embodiments, animation of the avatar may be based on speech of the user, when visual conditions for facial expression tracking are below a quality threshold. Resultantly, better user experience may be provided.

In embodiments, facial expression and speech tracker 102 may be configured to receive speech of a user, e.g., in the form of audio signals 116, from an audio capturing device 112, such as a microphone, and a plurality of image frames 118, e.g., from an image capturing device 114, such as a camera. Further, facial expression and speech tracker 102 may be configured to analyze audio signals 116 for speech. Facial expression and speech tracker 102 may further be configured to receive image frames 118 from an image capturing device 114, e.g., a camera. Facial expression and speech tracker 102 may analyze image frames 118 for facial expressions, including visual conditions of the image frames. Still further, facial expression and speech tracker 102 may be configured to output a plurality animation messages to drive animation an avatar, based one either the determined speech or the determined facial expressions, depending on whether the visual conditions for facial expression tracking are below, at, or above a quality threshold.

In embodiments, for efficiency of operation, pocket avatar system 100 may be configured to animate an avatar with a plurality of pre-defined blend shapes, making pocket avatar system 100 particularly suitable for a wide range of mobile devices. A model with neutral expression and some typical expressions, such as mouth open, mouth smile, brow-up, and brow-down, blink, etc., may be first pre-constructed, in advance. The blend shapes may be decided or selected for various facial expression and speech tracker 102 capabilities and target mobile device system requirements. During operation, facial expression and speech tracker 102 may select various blend shapes, and assign the blend shape weights, based on the facial expression and/or speech determined. The selected blend shapes and their assigned weights may be output as part of animation messages 120.

On receipt of the blend shape selection, and the blend shape weights (αᵢ), avatar animation engine 104 may generate the expressed facial results with the following formula (Eq. 1):

$${B}^{*} = {B}_{0} + {\sum }_{i} {α}_{i} \cdot Δ {B}_{i}$$

where B* is the target expressed facial,
B₀ is the base model with neutral expression, and
ΔBᵢ is i^{th} blend shape that stores the vertex position offset based on base model for specific expression.

More specifically, in embodiments, facial expression and speech tracker 102 may be configured with facial expression tracking function 122, speech tracking function 124, and animation message generation function 126. In embodiments, facial expression tracking function 122 may be configured to detect facial action movements of a face of a user and/or head pose gestures of a head of the user, within the plurality of image frames, and output a plurality of facial parameters that depict the determined facial expressions and/or head poses, in real time. For examples, the plurality of facial motion parameters may depict facial action movements detected, such as, eye and/or mouth movements, and/or head pose gesture parameters that depict head pose gestures detected, such as head rotation, movement, and/or coming closer or farther from the camera.

Additionally, facial expression tracking function 122 may be configured to determine visual conditions of image frames 118 for facial expression tracking. Examples of visual conditions that may provide indication of the suitably of image frames 118 for facial expression tracking may include, but are not limited to, lighting conditions of image frames 118, focus of objects in image frames 118 and/or motion of objects within image frames 118. In other words, if the lighting condition is too dark or too bright, or the objects are out of focus or move around a lot (e.g., due to camera shaking or the user is walking), the image frames may not be a good source for determining facial expressions of the user. On the other hand, if the lighting condition is optimal (not too dark, nor too bright), and the objects are in focus or has little movements, the image frames may be a good source for determining facial expressions of the user.

In embodiments, facial action movements and head pose gestures may be detected, e.g., through inter-frame differences for a mouth and an eye on the face, and the head, based on pixel sampling of the image frames. Various ones of the function blocks may be configured to calculate rotation angles of the user's head, including pitch, yaw and/or roll, and translation distance along horizontal, vertical direction, and coming closer or going farther from the camera, eventually output as part of the head pose gesture parameters. The calculation may be based on a subset of sub-sampled pixels of the plurality of image frames, applying, e.g., dynamic template matching, re-registration, and so forth. These function blocks may be sufficiently accurate, yet scalable in their processing power required, making pocket avatar system 100 particularly suitable to be hosted by a wide range of mobile computing devices, such as smartphones and/or computing tablets.

In embodiments, the visual conditions may be checked by dividing an image frame into grids, generate a gray histogram, and compute the statistical variance between the grids to check whether the light is too poor, or too strong, or quite non-uniform (i.e., below a quality threshold). Under these conditions, the facial tracking result is likely not robust or reliable. On the other hand, if the user's face has not been captured for a number of image frames, the visual condition may also be inferred as not good, or below a quality threshold.

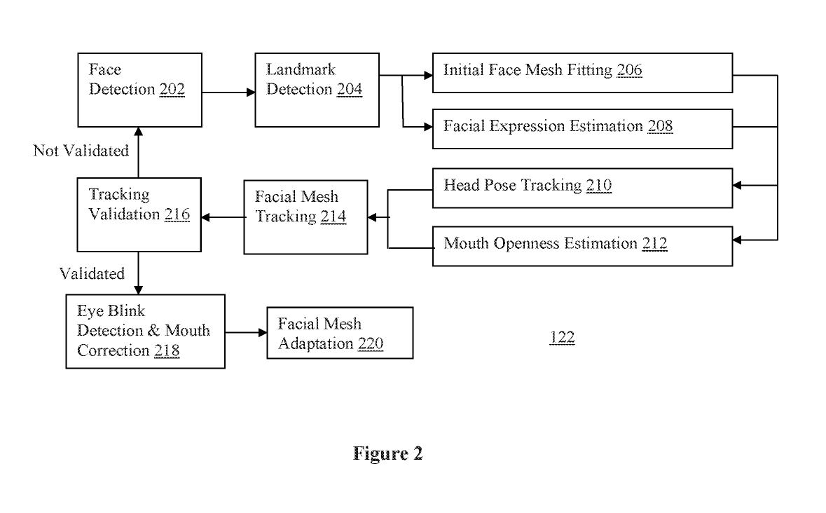

An example facial expression tracking function 122 will be further described later with references to FIG. 2.

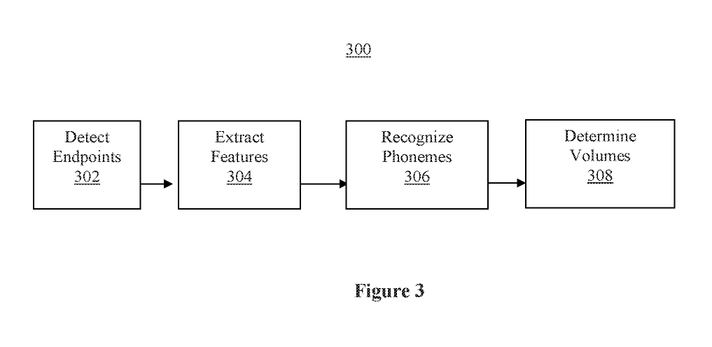

In embodiments, speech tracking function 124 may be configured to analyze audio signals 116 for speech of the user, and output a plurality of speech parameters that depict the determined speech, in real time. Speech tracking function 124 may be configured to identify sentences with the speech, parse each sentence into words, and parse each word into phonemes. Speech tracking function 124 may also be configured to determine volumes of the speech. Accordingly, the plurality of speech parameters may depict phonemes and volumes of the speech. An example process for detecting phonemes and volumes of speech of a user will be further described later with references to FIG. 3.

In embodiments, animation message generation function 126 may be configured to selectively output animation messages 120 to drive animation of an avatar, based either on the speech parameters depicting speech of the user or facial expression parameters depicting facial expressions of the user, depending on the visual conditions of image frames 118. For example, animation message generation function 126 may be configured to selectively output animation messages 120 to drive animation of an avatar, based on the facial expression parameters, when visual conditions for facial expression tracking are determined to be at or above a quality threshold, and based on the speech parameters, when visual conditions for facial expression tracking are determined to be below the quality threshold.

In embodiments, animation message generation function 126 may be configured to convert facial action units or speech units into blend-shapes and their assigned weights for animation of an avatar. Since face tracking may use different mesh geometry and animation structure with avatar rendering side, animation message generation function 126 may also be configured to perform animation coefficient conversion and face model retargeting. In embodiments, animation message generation function 126 may output the blend shapes and their weights as animation messages 120. Animation message 120 may specify a number of animations, such as “lower lip down” (LLIPD), “both lips widen” (BLIPW), “both lips up” (BLIPU), “nose wrinkle” (NOSEW), “eyebrow down” (BROWD), and so forth.

Still referring to FIG. 1, avatar animation engine 104 may be configured to receive animation messages 120 outputted by facial expression and speech tracker 102, and drive an avatar model to animate the avatar, to replicate facial expressions and/or speech of the user on the avatar. Avatar rendering engine 106 may be configured to draw the avatar as animated by avatar animation engine 104.

In embodiments, avatar animation engine 104, when animating based on animation messages 120 generated in view of facial expression parameters, may optionally factor in head rotation impact, in accordance with head rotation impact weights, provided by head rotation impact weights generator 108. Head rotation impact weight generator 108 may be configured to pre-generate head rotation impact weights 110 for avatar animation engine 104. In these embodiments, avatar animation engine 104 may be configured to animate an avatar through facial and skeleton animations and application of head rotation impact weights 110. The head rotation impact weights 110, as described earlier, may be pre-generated by head rotation impact weight generator 108 and provided to avatar animation engine 104, in e.g., the form of a head rotation impact weight map. Avatar Animation taking into consideration of head rotation impact weight is the subject of co-pending patent application, PCT Patent Application No. PCT/CN2014/082989, entitled “AVATAR FACIAL EXPRESSION ANIMATIONS WITH HEAD ROTATION,” filed Jul. 25, 2014. For further information, see PCT Patent Application No. PCT/CN2014/082989.

Facial expression and speech tracker 102, avatar animation engine 104 and avatar rendering engine 106, may each be implemented in hardware, e.g., Application Specific Integrated Circuit (ASIC) or programmable devices, such as Field Programmable Gate Arrays (FPGA) programmed with the appropriate logic, software to be executed by general and/or graphics processors, or a combination of both.

Compared with other facial animation techniques, such as motion transferring and mesh deformation, using blend shape for facial animation may have several advantages: 1) Expressions customization: expressions may be customized according to the concept and characteristics of the avatar, when the avatar models are created. The avatar models may be made more funny and attractive to users. 2) Low computation cost: the computation may be configured to be proportional to the model size, and made more suitable for parallel processing. 3) Good scalability: addition of more expressions into the framework may be made easier.

It will be apparent to those skilled in the art that these features, individually and in combination, make pocket avatar system 100 particularly suitable to be hosted by a wide range of mobile computing devices. However, while pocket avatar system 100 is designed to be particularly suitable to be operated on a mobile device, such as a smartphone, a phablet, a computing tablet, a laptop computer, or an e-reader, the disclosure is not to be so limited. It is anticipated that pocket avatar system 100 may also be operated on computing devices with more computing power than the typical mobile devices, such as a desktop computer, a game console, a set-top box, or a computer server. The foregoing and other aspects of pocket avatar system 100 will be described in further detail in turn below.

Referring now to FIG. 2, wherein an example implementation of the facial expression tracking function of FIG. 1 is illustrated in further detail, according to various embodiments. As shown, in embodiments, facial expression tracking function 122 may include face detection function block 202, landmark detection function block 204, initial face mesh fitting function block 206, facial expression estimation function block 208, head pose tracking function block 210, mouth openness estimation function block 212, facial mesh tracking function block 214, tracking validation function block 216, eye blink detection and mouth correction function block 218, and facial mesh adaptation block 220 coupled with each other as shown.

In embodiments, face detection function block 202 may be configured to detect the face through window scan of one or more of the plurality of image frames received. At each window position, modified census transform (MCT) features may be extracted and a cascade classifier may be applied to look for the face. Landmark detection function block 204 may be configured to detect landmark points on the face, e.g., eye centers, nose-tip, mouth corners, and face contour points. Given a face rectangle, an initial landmark position may be given according to mean face shape. Thereafter, the exact landmark positions may be found iteratively through an explicit shape regression (ESR) method.

In embodiments, initial face mesh fitting function block 206 may be configured to initialize a 3D pose of a face mesh based at least in part on a plurality of landmark points detected on the face. A Candide3 wireframe head model may be used. The rotation angles, translation vector and scaling factor of the head model may be estimated using the POSIT algorithm. Resultantly, the projection of the 3D mesh on the image plane may match with the 2D landmarks. Facial expression estimation function block 208 may be configured to initialize a plurality of facial motion parameters based at least in part on a plurality of landmark points detected on the face. The Candide3 head model may be controlled by facial action parameters (FAU), such as mouth width, mouth height, nose wrinkle, eye opening. These FAU parameters may be estimated through least square fitting.

Head pose tracking function block 210 may be configured to calculate rotation angles of the user's head, including pitch, yaw and/or roll, and translation distance along horizontal, vertical direction, and coming closer or going farther from the camera. The calculation may be based on a subset of sub-sampled pixels of the plurality of image frames, applying dynamic template matching and re-registration. Mouth openness estimation function block 212 may be configured to calculate opening distance of an upper lip and a lower lip of the mouth. The correlation of mouth geometry (opening/closing) and appearance may be trained using a sample database. Further, the mouth opening distance may be estimated based on a subset of sub-sampled pixels of a current image frame of the plurality of image frames, applying FERN regression.

Facial mesh tracking function block 214 may be configured to adjust position, orientation or deformation of a face mesh to maintain continuing coverage of the face and reflection of facial movement by the face mesh, based on a subset of sub-sampled pixels of the plurality of image frames. The adjustment may be performed through image alignment of successive image frames, subject to pre-defined FAU parameters in Candide3 model. The results of head pose tracking function block 210 and mouth openness may serve as soft-constraints to parameter optimization. Tracking validation function block 216 may be configured to monitor face mesh tracking status, to determine whether it is necessary to re-locate the face. Tracking validation function block 216 may apply one or more face region or eye region classifiers to make the determination. If the tracking is running smoothly, operation may continue with next frame tracking, otherwise, operation may return to face detection function block 202, to have the face re-located for the current frame.

Eye blink detection and mouth correction function block 218 may be configured to detect eye blinking status and mouth shape. Eye blinking may be detected through optical flow analysis, whereas mouth shape/movement may be estimated through detection of inter-frame histogram differences for the mouth. As refinement of whole face mesh tracking, eye blink detection and mouth correction function block 216 may yield more accurate eye-blinking estimation, and enhance mouth movement sensitivity.

Face mesh adaptation function block 220 may be configured to reconstruct a face mesh according to derived facial action units, and re-sample of a current image frame under the face mesh to set up processing of a next image frame.

Example facial expression tracking function 122 is the subject of co-pending patent application, PCT Patent Application No. PCT/CN2014/073695, entitled “FACIAL EXPRESSION AND/OR INTERACTION DRIVEN AVATAR APPARATUS AND METHOD,” filed Mar. 19, 2014. As described, the architecture, distribution of workloads among the functional blocks render facial expression tracking function 122 particularly suitable for a portable device with relatively more limited computing resources, as compared to a laptop or a desktop computer, or a server. For further details, refer to PCT Patent Application No. PCT/CN2014/073695.

In alternate embodiments, facial expression tracking function 122 may be any one of a number of other face trackers known in the art.

Referring now to FIG. 3, wherein an example process for tracking and analyzing speech of a user, according to various embodiments, is shown. As illustrated, process 300 for tracking and analyzing speech of a user may include operations performed in blocks 302-308. The operations may be performed e.g., by speech tracking function 124 of FIG. 1. In alternate embodiments, process 300 may be performed with less or additional operations, or with modifications to the order of their performance.

Overall, process 300 may divide the speech into sentences, then parse each sentence into words, and then parse each word into phonemes. A phoneme is a basic unit of a language's phonology, which is combined with other phonemes to form meaningful units such as words or morphemes. To do so, as shown, process 300 may begin at block 302. At block 302, the audio signals may be analyzed to have the background noise removed, and the endpoints that divide the speech into sentences identified. In embodiments, independent component analysis (ICA) or computational auditory scene analysis (CASA) technologies may be employed to separate speech from background noise in the audio.

Next, at block 304, the audio signals may be analyzed for features to allow words to be recognized. In embodiments, the features may be identified/extracted by determining e.g., mel-frequency cepstral coefficients (MFCCs). The coefficients collectively represent a MFC, which is a representation of the short-term power spectrum of a sound, based on a linear cosine transform of a log power spectrum on a nonlinear mel scale of frequency.

At block 306, phonemes of each word may be determined. In embodiments, the phonemes of each word may be determined using e.g., a hidden Markov model (HMM). In embodiments, speech tracking function 124 may be pre-trained using a database with a substantial number of speech samples.

At block 308, volumes of the various speech parts may be determined.

As described earlier, the phonemes may be used to select the blend shapes to animate an avatar based on speech, and the volumes of the speech parts may be used to determine the weights of the various blend shapes.

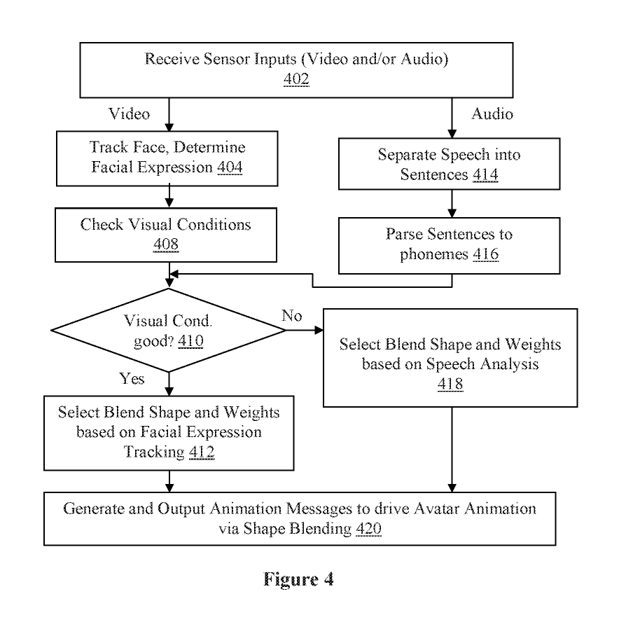

FIG. 4 is a flow diagram illustrating an example process for animating an avatar based on facial expressions or speech of a user, according to various embodiments. As illustrated, process 400 for animating avatar based on facial expressions or speech of a user may include operations performed in blocks 402-420. The operations may be performed e.g., by facial expression and speech tracker 102 of FIG. 1. In alternate embodiments, process 400 may be performed with less or additional operations, or with modifications to the order of their performance.

As illustrated, process 400 may start at block 402. At block 402, audio and/or video (image frames) may be received from various sensors, such as microphones, cameras and so forth. For video signals (image frames), process 400 may proceed to block 404, and for audio signals, process 400 may proceed to block 414.

At block 404, the image frames may be analyzed to track a user's face, and determine its facial expressions, including e.g., facial motions, head pose, and so forth. Next, at block 406, the image frames may further be analyzed to determine visual conditions of the image frames, such as lighting condition, focus, motion, and so forth.

At block 414, the audio signals may be analyzed and separate into sentences. Next at block 416, each sentence may be parsed into words, and then each word may be parsed into phonemes.

From blocks 408 and 416, process 400 may proceed to block 410. At block 410, a determination may be made on whether visual conditions of the image frames are below, at or above a quality threshold for tracking facial expressions. If a result of the determination indicates the visual conditions are at or above a quality threshold, process 400 may proceed to block 412, otherwise, to block 418.

At block 412, blend shapes for animating the avatar may be selected, including assignment of their weights, based on results of the facial expression tracking. On the other hand, at block 418, blend shapes for animating the avatar may be selected, including assignment of their weights, based on results of the speech tracking.

From block 412 or 418, process 400 may proceed to block 420. At block 420, animation messages containing information about the selected blend shapes and their corresponding weights may be generated and output for animation of an avatar.

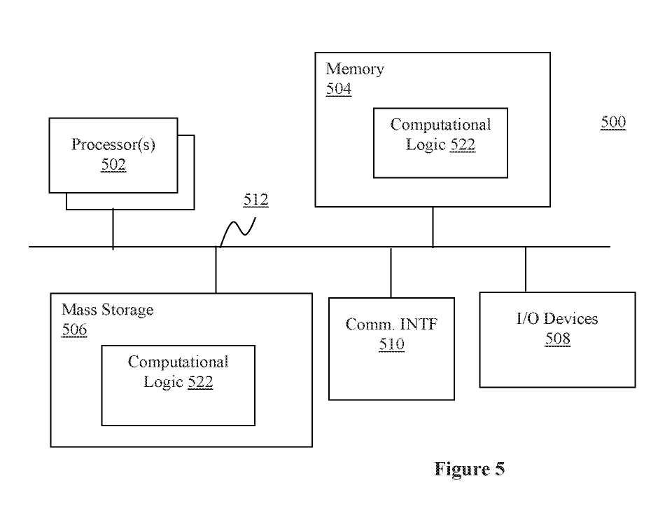

FIG. 5 illustrates an example computer system that may be suitable for use as a client device or a server to practice selected aspects of the present disclosure. As shown, computer 500 may include one or more processors or processor cores 502, and system memory 504. For the purpose of this application, including the claims, the terms “processor” and “processor cores” may be considered synonymous, unless the context clearly requires otherwise. Additionally, computer 500 may include mass storage devices 506 (such as diskette, hard drive, compact disc read only memory (CD-ROM) and so forth), input/output devices 508 (such as display, keyboard, cursor control and so forth) and communication interfaces 510 (such as network interface cards, modems and so forth). The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage devices 506 may be employed to store a working copy and a permanent copy of the programming instructions implementing the operations associated with facial expression and speech tracker 102, avatar animation engine 104, and/or avatar rendering engine 106, earlier described, collectively referred to as computational logic 522. The various elements may be implemented by assembler instructions supported by processor(s) 502 or high-level languages, such as, for example, C, that can be compiled into such instructions.

The number, capability and/or capacity of these elements 510-512 may vary, depending on whether computer 500 is used as a client device or a server. When use as client device, the capability and/or capacity of these elements 510-512 may vary, depending on whether the client device is a stationary or mobile device, like a smartphone, computing tablet, ultrabook or laptop. Otherwise, the constitutions of elements 510-512 are known, and accordingly will not be further described.

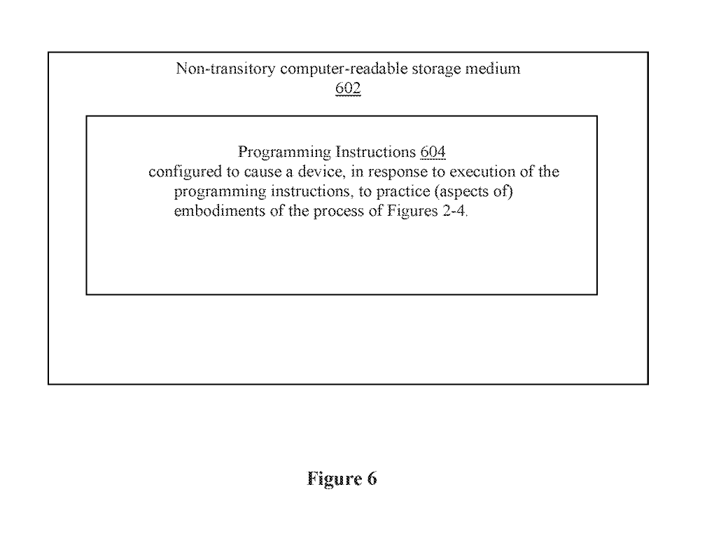

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computer 500, in response to execution of the programming instructions, to perform, e.g., various operations associated with facial expression and speech tracker 102, avatar animation engine 104, and/or avatar rendering engine 106. In alternate embodiments, programming instructions 604 may be disposed on multiple computer-readable non-transitory storage media 602 instead. In alternate embodiments, programming instructions 604 may be disposed on computer-readable transitory storage media 602, such as, signals.

Any combination of one or more computer usable or computer readable media may be utilized. The computer-usable or computer-readable medium/media may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium/media could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 5, for one embodiment, at least one of processors 502 may be packaged together with memory having computational logic 522 (in lieu of storing on memory 504 and storage 506). For one embodiment, at least one of processors 502 may be packaged together with memory having computational logic 522 to form a System in Package (SiP). For one embodiment, at least one of processors 502 may be integrated on the same die with memory having computational logic 522. For one embodiment, at least one of processors 502 may be packaged together with memory having computational logic 522 to form a System on Chip (SoC). For at least one embodiment, the SoC may be utilized in, e.g., but not limited to, a smartphone or computing tablet.

Thus various example embodiments of the present disclosure have been described including, but are not limited to:

Example 1 may an apparatus for animating an avatar. The apparatus may comprise one or more processors; and a facial expression and speech tracker. The facial expression and speech tracker may include a facial expression tracking function and a speech tracking function, to be operated by the one or more processors to respectively receive a plurality of image frames and audio of a user, and analyze the image frames and the audio to determine and track facial expressions and speech of the user. The facial expression and speech tracker may further include an animation message generation function to select a plurality of blend shapes, including assignment of weights of the blend shapes, for animating the avatar, based on tracked facial expressions or speech of the user. The animation message generation function may be configured to select the plurality of blend shapes, including assignment of weights of the blend shapes, based on the tracked speech of the user, when visual conditions for tracking facial expressions of the user are determined to be below a quality threshold.

Example 2 may be example 1, wherein the animation message generation function may be configured to select the plurality of blend shapes, including assignment of weights of the blend shapes, based on the tracked facial expressions of the user, when visual conditions for tracking facial expressions of the user are determined to be at or above a quality threshold.

Example 3 may be example 1, wherein the facial expression tracking function may be configured to further analyze the visual conditions of the image frames, and the animation message generation function is to determine whether the visual conditions are below, at, or above a quality threshold, for tracking facial expressions of the user.

Example 4 may be example 3, wherein to analyze the visual conditions of the image frames, the facial expression tracking function may be configured to analyze lighting condition, focus or motion of the image frames.

Example 5 may be any one of examples 1-4 wherein to analyze the audio, and track speech of the user, the speech tracking function may be configured to receive and analyze the audio of the user to determine sentences, parse each sentence into words, and then parse each word into phonemes.

Example 6 may be example 5, wherein the speech tracking function may be configured to analyze the audio for endpoints to determine the sentences, extract features of the audio to identify words of the sentences, and apply a model to identify the phonemes of each word.

Example 7 may be example 5, wherein the speech tracking function may be configured to further determine volumes of the speech.

Example 8 may be example 7, wherein the animation message generation function may be configured to select the blend shapes, and assign weights to the selected blend shapes, in accordance with the phonemes and volumes of the speech determined, when the animation message generation function selects the blend shapes and assigns weights to the selected blend shapes, based on the speech of the user.

Example 9 may be example 5, wherein to analyze the image frames and track facial expression of the user, the facial expression tracking function may be configured to receive and analyze the image frames of the user, to determine facial motion and head pose of the user.

Example 10 may be example 9, wherein the animation message generation function may be configured to select the blend shapes, and assign weights to the selected blend shapes, in accordance with the facial motion and head pose determined, when the animation message generation function selects the blend shapes and assign weights to the selected blend shapes, based on the facial expressions of the user.

Example 11 may be example 9, further comprising an avatar animation engine, operated by the one or more processors, to animate the avatar using the selected and weighted blend shapes; and an avatar rendering engine coupled with the avatar animation engine and operated by the one or more processors, to draw the avatar as animated by the avatar animation engine.

Example 12 may be a method for rendering an avatar. The method may comprise receiving, by a computing device, a plurality of image frames and audio of a user; respectively analyzing, by the computing device, the image frames and the audio to determine and track facial expressions and speech of the user; and selecting, by the computing device, a plurality of blend shapes, including assigning weights of the blend shapes, for animating the avatar, based on tracked facial expressions or speech of the user. Further, selecting the plurality of blend shapes, including assignment of weights of the blend shapes, may be based on the tracked speech of the user, when visual conditions for tracking facial expressions of the user are determined to be below a quality threshold.

Example 13 may be example 12, wherein selecting a plurality of blend shapes may comprise selecting a plurality of blend shapes, including assigning weights of the blend shapes, based on the tracked facial expressions of the user, when visual conditions for tracking facial expressions of the user are determined to be at or above a quality threshold.

Example 14 may be example 12, further comprising analyzing, by the computing device, the visual conditions of the image frames, and determining whether the visual conditions are below, at, or above a quality threshold, for tracking facial expressions of the user.

Example 15 may be example 14, wherein analyzing the visual conditions of the image frames may comprise analyzing lighting condition, focus or motion of the image frames.

Example 16 may be any one of examples 12-15 wherein analyzing the audio, and tracking speech of the user may comprise receiving and analyzing the audio of the user to determine sentences, parse each sentence into words, and then parse each word into phonemes.

Example 17 may be example 16, wherein analyzing may comprise analyzing the audio for endpoints to determine the sentences, extracting features of the audio to identify words of the sentences, and applying a model to identify the phonemes of each word.

Example 18 may be example 16, wherein analyzing the audio, and tracking speech of the user may further comprise determining volumes of the speech.

Example 19 may be example 18, wherein selecting the blend shapes may comprise selecting the blend shapes, and assigning weights to the selected blend shapes, in accordance with the phonemes and volumes of the speech determined, when selecting the blend shapes and assigning weights to the selected blend shapes are based on the speech of the user.

Example 20 may be example 16, wherein analyzing the image frames and tracking facial expression of the user may comprise receiving and analyzing the image frames of the user, to determine facial motion and head pose of the user.

Example 21 may be example 20, wherein selecting the blend shapes may comprise selecting the blend shapes, and assigning weights to the selected blend shapes, in accordance with the facial motion and head pose determined, when selecting the blend shapes and assigning weights to the selected blend shapes are based on the facial expressions of the user.

Example 22 may be example 20, further comprising animating, by the computing device, the avatar using the selected and weighted blend shapes; and drawing, by the computing device, the avatar as animated.

Example 23 may be a computer-readable medium comprising instructions to cause an computing device, in response to execution of the instructions by the computing device, to: receive a plurality of image frames and audio of a user, and respectively analyze the image frames and the audio to determine and track facial expressions and speech of the user; and select a plurality of blend shapes, including assignment of weights of the blend shapes, for animating the avatar, based on tracked facial expressions or speech of the user. Further, selection of the plurality of blend shapes, including assignment of weights of the blend shapes, may be based on the tracked speech of the user, when visual conditions for tracking facial expressions of the user are determined to be below a quality threshold.

Example 24 may be example 23, wherein to select the plurality of blend shapes may comprise to select the plurality of blend shapes, including assignment of weights of the blend shapes, based on the tracked facial expressions of the user, when visual conditions for tracking facial expressions of the user are determined to be at or above a quality threshold.

Example 25 may be example 23, wherein the computing device may be further caused to analyze the visual conditions of the image frames, and to determine whether the visual conditions are below, at, or above a quality threshold, for tracking facial expressions of the user.

Example 26 may be example 25, wherein to analyze the visual conditions of the image frames may comprise to analyze lighting condition, focus or motion of the image frames.

Example 27 may be any one of examples 23-26 wherein to analyze the audio, and track speech of the user may comprise to receive and analyze the audio of the user to determine sentences, parse each sentence into words, and then parse each word into phonemes.

Example 28 may be example 27, wherein to analyze the audio may comprise to analyze the audio for endpoints to determine the sentences, extract features of the audio to identify words of the sentences, and apply a model to identify the phonemes of each word.

Example 29 may be example 27, wherein the computing device may be further caused to determine volumes of the speech.

Example 30 may be example 29, wherein to select the blend shapes may comprise to select the blend shapes, and assign weights to the selected blend shapes, in accordance with the phonemes and volumes of the speech determined, when the animation message generation function selects the blend shapes and assigns weights to the selected blend shapes, based on the speech of the user.

Example 31 may be example 27, wherein to analyze the image frames and track facial expression of the user may comprise to receive and analyze the image frames of the user, to determine facial motion and head pose of the user.

Example 32 may be example 31, wherein to select the blend shapes may comprise to select the blend shapes, and assign weights to the selected blend shapes, in accordance with the facial motion and head pose determined, when selects the blend shapes and assign weights to the selected blend shapes, based on the facial expressions of the user.

Example 33 may be example 31, wherein the computing device may be further caused to animate the avatar using the selected and weighted blend shapes, and to draw the avatar as animated.

Example 34 may be an apparatus for rendering an avatar. The apparatus may comprise: means for receiving a plurality of image frames and audio of a user; means for respectively analyzing the image frames and the audio to determine and track facial expressions and speech of the user; and means for selecting a plurality of blend shapes, including assignment of weights of the blend shapes, for animating the avatar, based on tracked facial expressions or speech of the user. Further, means for selecting may include means for selecting the plurality of blend shapes, including assignment of weights of the blend shapes, based on the tracked speech of the user, when visual conditions for tracking facial expressions of the user are determined to be below a quality threshold.

Example 35 may be example 34, wherein means for selecting a plurality of blend shapes may comprise means for selecting a plurality of blend shapes, including assigning weights of the blend shapes, based on the tracked facial expressions of the user, when visual conditions for tracking facial expressions of the user are determined to be at or above a quality threshold.

Example 36 may be example 34, further comprising means for analyzing the visual conditions of the image frames, and determining whether the visual conditions are below, at, or above a quality threshold, for tracking facial expressions of the user.

Example 37 may be example 36, wherein means for analyzing the visual conditions of the image frames may comprise means for analyzing lighting condition, focus or motion of the image frames.

Example 38 may be any one of examples 34-37 wherein means for analyzing the audio, and tracking speech of the user may comprise means for receiving and analyzing the audio of the user to determine sentences, parse each sentence into words, and then parse each word into phonemes.

Example 39 may be example 38, wherein means for analyzing may comprise means for analyzing the audio for endpoints to determine the sentences, extracting features of the audio to identify words of the sentences, and applying a model to identify the phonemes of each word.

Example 40 may be example 38, wherein means for analyzing the audio, and tracking speech of the user further may comprise means for determining volumes of the speech.

Example 41 may be example 40, wherein means for selecting the blend shapes may comprise means for selecting the blend shapes, and assigning weights to the selected blend shapes, in accordance with the phonemes and volumes of the speech determined, when selecting the blend shapes and assigning weights to the selected blend shapes are based on the speech of the user.

Example 42 may be example 38, wherein means for analyzing the image frames and tracking facial expression of the user may comprise means for receiving and analyzing the image frames of the user, to determine facial motion and head pose of the user.

Example 43 may be example 42, wherein means for selecting the blend shapes may comprise means for selecting the blend shapes, and assigning weights to the selected blend shapes, in accordance with the facial motion and head pose determined, when selecting the blend shapes and assigning weights to the selected blend shapes are based on the facial expressions of the user.

Example 44 may be example 42, further comprising means for animating the avatar using the selected and weighted blend shapes; and means for drawing the avatar as animated.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claim and its equivalents.

1. An apparatus for animating an avatar, comprising:
one or more processors; and
a facial expression and speech tracker, including a facial expression tracking function and a speech tracking function, to be operated by the one or more processors to respectively receive a plurality of image frames and audio of a user, and analyze the image frames and the audio to determine and track facial expressions and speech of the user;
wherein the facial expression and speech tracker further includes an animation message generation function to select a plurality of blend shapes, including assignment of weights of the blend shapes, for animating the avatar, based on tracked facial expressions or speech of the user;
wherein the animation message generation function is to select the plurality of blend shapes, including assignment of weights of the blend shapes, based on the tracked speech of the user, when visual conditions for tracking facial expressions of the user are determined to be below a quality threshold.

2. The apparatus of claim 1, wherein the animation message generation function is to select the plurality of blend shapes, including assignment of weights of the blend shapes, based on the tracked facial expressions of the user, when visual conditions for tracking facial expressions of the user are determined to be at or above a quality threshold.

3. The apparatus of claim 1, wherein the facial expression tracking function is to further analyze the visual conditions of the image frames, and the animation message generation function is to determine whether the visual conditions are below, at, or above a quality threshold, for tracking facial expressions of the user.

4. The apparatus of claim 3, wherein to analyze the visual conditions of the image frames, the facial expression tracking function is to analyze lighting condition, focus or motion of the image frames.

5. The apparatus of claim 1 wherein to analyze the audio, and track speech of the user, the speech tracking function is to receive and analyze the audio of the user to determine sentences, parse each sentence into words, and then parse each word into phonemes.

6. The apparatus of claim 5, wherein the speech tracking function is to analyze the audio for endpoints to determine the sentences, extract features of the audio to identify words of the sentences, and apply a model to identify the phonemes of each word.

7. The apparatus of claim 5, wherein the speech tracking function is to further determine volumes of the speech.

8. The apparatus of claim 7, wherein the animation message generation function is to select the blend shapes, and assign weights to the selected blend shapes, in accordance with the phonemes and volumes of the speech determined, when the animation message generation function selects the blend shapes and assigns weights to the selected blend shapes, based on the speech of the user.

9. The apparatus of claim 5, wherein to analyze the image frames and track facial expression of the user, the facial expression tracking function is to receive and analyze the image frames of the user, to determine facial motion and head pose of the user.

10. The apparatus of claim 9, wherein the animation message generation function is to select the blend shapes, and assign weights to the selected blend shapes, in accordance with the facial motion and head pose determined, when the animation message generation function selects the blend shapes and assign weights to the selected blend shapes, based on the facial expressions of the user.

11. The apparatus of claim 9, further comprising an avatar animation engine, operated by the one or more processors, to animate the avatar using the selected and weighted blend shapes; and an avatar rendering engine coupled with the avatar animation engine and operated by the one or more processors, to draw the avatar as animated by the avatar animation engine.

12. A method for rendering an avatar, comprising:
receiving, by a computing device, a plurality of image frames and audio of a user;
respectively analyzing, by the computing device, the image frames and the audio to determine and track facial expressions and speech of the user; and
selecting, by the computing device, a plurality of blend shapes, including assigning weights of the blend shapes, for animating the avatar, based on tracked facial expressions or speech of the user;
wherein selecting the plurality of blend shapes, including assignment of weights of the blend shapes, is based on the tracked speech of the user, when visual conditions for tracking facial expressions of the user are determined to be below a quality threshold.

13. (canceled)

14. The method of claim 12, further comprising analyzing, by the computing device, the visual conditions of the image frames, and determining whether the visual conditions are below, at, or above a quality threshold, for tracking facial expressions of the user; wherein analyzing the visual conditions of the image frames comprises analyzing lighting condition, focus or motion of the image frames.

15. (canceled)

16. The method of claim 12 wherein analyzing the audio, and tracking speech of the user comprises receiving and analyzing the audio of the user to determine sentences, parse each sentence into words, and then parse each word into phonemes; wherein analyzing comprises analyzing the audio for endpoints to determine the sentences, extracting features of the audio to identify words of the sentences, and applying a model to identify the phonemes of each word.

17. (canceled)

18. The method of claim 16, wherein analyzing the audio, and tracking speech of the user further comprises determining volumes of the speech.

19. (canceled)

20. (canceled)

21. (canceled)

22. (canceled)

23. (canceled)

24. (canceled)

25. (canceled)

26. A computer-readable medium comprising instructions to cause an computing device, in response to execution of the instructions, to:
receive a plurality of image frames and audio of a user, and respectively analyze the image frames and the audio to determine and track facial expressions and speech of the user; and
select a plurality of blend shapes, including assignment of weights of the blend shapes, for animating the avatar, based on tracked facial expressions or speech of the user;
wherein selection of the plurality of blend shapes, including assignment of weights of the blend shapes, is based on the tracked speech of the user, when visual conditions for tracking facial expressions of the user are determined to be below a quality threshold.

27. The computer-readable medium of claim 26, wherein to select the plurality of blend shapes comprises to select the plurality of blend shapes, including assignment of weights of the blend shapes, based on the tracked facial expressions of the user, when visual conditions for tracking facial expressions of the user are determined to be at or above a quality threshold.

28. The computer-readable medium of claim 26, wherein the computing device is further caused to analyze the visual conditions of the image frames, and to determine whether the visual conditions are below, at, or above a quality threshold, for tracking facial expressions of the user.

29. The computer-readable medium of claim 28, wherein to analyze the visual conditions of the image frames comprises to analyze lighting condition, focus or motion of the image frames.

30. The computer-readable medium of claim 26, wherein to analyze the audio, and track speech of the user comprises to receive and analyze the audio of the user to determine sentences, parse each sentence into words, and then parse each word into phonemes.

31. The computer-readable medium of claim 30, wherein to analyze the audio comprises to analyze the audio for endpoints to determine the sentences, extract features of the audio to identify words of the sentences, and apply a model to identify the phonemes of each word.

32. The computer-readable medium of claim 30, wherein the computing device is further caused to determine volumes of the speech.

33. The computer-readable medium of claim 32, wherein to select the blend shapes comprises to select the blend shapes, and assign weights to the selected blend shapes, in accordance with the phonemes and volumes of the speech determined, when the animation message generation function selects the blend shapes and assigns weights to the selected blend shapes, based on the speech of the user.

34. The computer-readable medium of claim 30, wherein to analyze the image frames and track facial expression of the user comprises to receive and analyze the image frames of the user, to determine facial motion and head pose of the user.

35. The computer-readable medium of claim 34, wherein to select the blend shapes comprises to select the blend shapes, and assign weights to the selected blend shapes, in accordance with the facial motion and head pose determined, when selects the blend shapes and assign weights to the selected blend shapes, based on the facial expressions of the user.
